(19) United States
(12) Patent Application Publication
(10) Pub. No.: US 2014/0273880 A1
(43) Pub. Date: Sep. 18, 2014

(54) Methods and Apparatus for Dynamically Limiting Mobile Device Functional State

(71) Applicants: Caleb Sima, San Francisco, CA (US); Jeffrey Forristal, San Francisco, CA (US); Khiem Chan Truong, San Francisco, CA (US)

(72) Inventors: Caleb Sima, San Francisco, CA (US); Jeffrey Forristal, San Francisco, CA (US); Khiem Chan Truong, San Francisco, CA (US)

(73) Assignee: Bluebox Security Inc., San Francisco, CA (US)

(21) Appl. No.: 14/205,692

(22) Filed: Mar. 12, 2014

Related U.S. Application Data
(60) Provisional application No. 61/778,154, filed on Mar. 12, 2013.

(51) Int. Cl. H04W 12/08

(52) U.S. Cl. CPC H04W 12/08
USPC 455/68

(57) ABSTRACT

The present invention provides a computer-implemented method in a mobile device programmed for the method, includes receiving in the mobile device, an indication to enter a limited functionality mobile device state, and initiating in the mobile device, a limited functionality mobile device state. In this way a mobile device can be temporarily suspended in some or all operations, including functionality that could cause the loss of private or privileged information or data. The method permits a manager to exercise discretion at the potential loss of the device or the potential recovery of the device so as to save its functionality by suspending for periods of time or acting to sever the device permanently. The method further allows automatic triggers to cause a device to enter a limited functionality state and emerge therefrom when the triggering situation no longer exists.

### CROSS-REFERENCES TO RELATED APPLICATIONS

The present application is a continuation of (provisional) Application No. 61/778,154; filed on Mar. 12, 2013, the full disclosures of which is incorporated herein by reference.

### FIELD OF THE INVENTION

The present invention concerns methods and apparatus for dynamically limiting functionality of a mobile device for a temporary period of time. More particularly, the present invention relates to the ability for the mobile device user, a mobile device manager, and the like, to inhibit access to data, files, and services of the mobile device under circumstances when the mobile device is to be used by an untrusted third party, is reported stolen, exhibits particular events or behavior relating to security, and the like.

### BACKGROUND OF THE INVENTION

It is known in the art to permanently suspend the operations of a mobile device that has been lost or stolen and to send a communications thereto to destroy all data on such a device in such a situation. Presently, the art is limited to an all or nothing situation wherein the device either remains active or is shut down and then the secondary effect of clearing the device of all data, effectively surrendering to the idea that the device is permanently lost. The prior state of the art does not allow for management of a mobile device such that the device can be temporarily suspended and/or limited to activity or have certain applications active with other access denied.

It is common for executives, government officials and employees of companies, the government and firms and the like to be issued a mobile device, such as a cellular telephone or an computing tablet or other device, for use in their daily work and to maintain communications with contacts, calendars, files, applications and other elements of the modern day work world. There are situations where such a device can be misplaced, put in the hands of an unreliable party or temporarily placed in a position where the contents of the device or its sensitive connectivity can be placed in jeopardy. In addition, there are situations, such as the composition of private emails or Internet searching, for which the user wishes to shield the company or agency to which the device belongs from exposure. In addition, there may be times or circumstance, such as the following, where free access to the device and its connectivity can cause jeopardy for the user and the device owner: the employee's employment is temporarily suspending due to criminal or other investigation; the user goes into a suspect foreign country, where, for example border/customs agents have the right to inspect the device contents (which can have the effect of exposing confidential data); strange security access/violations are occurring with that user account (hacked); the user wants to do something private without their employer necessarily monitoring their actions (review suspect web pages risking virus or other problems).

In all of these cases, it would be desirable to temporarily “suspend” access to employer resources (apps, documents, email, networks, VPN, etc.) while such situations are occurring. When the situation is resolved, it would then be as simple as the touching of a button, by an administrator or user, to unsuspend the device and place the device right back to where it originally was with all of its connectivity and function.

In addition, it is recognized that current mobile devices do not typically support the notion of multiple user accounts on the same device. Therefore, mobile devices cannot benefit from the use of alternate user accounts with limited configured access. It would be desirable to dynamically change existing mobile device functional state to support the concept of switching to one or more alternate user configurations, each configured with different or restricted access, and shielding the settings and access of one user from another.

Other objects and advantages of the present invention will become apparent as the description proceeds.

### SUMMARY OF THE INVENTION

In accordance with the present invention, a computer-implemented method for limiting access in a mobile device programmed for the method is provided. The method comprises the steps of receiving in the mobile device, an indication to enter a limited functionality mobile device state; and then initiating in the mobile device, a limited functionality mobile device state. The limited functionality state being a new and novel state that can subsequently be reversed, or as desired, be further modified to offer no functionality.

The method of the present invention comprises, when desiring to exit the limited functionality, the steps of receiving in the mobile device, an indication to exit a limited functionality mobile device state and then initiating in the mobile device, a full functionality mobile device state.

In one embodiment initiating a limited functionality mobile device state, comprises inhibiting in the mobile device, access to data stored in mobile device memory. In such cases inhibiting in the mobile device, can include limiting access to data stored in mobile device memory including, inhibiting access to data selected from a group consisting of: photographs, phone book, contact list, emails, messages, files, calendar entries, phone call history, web browser history, downloads, cached data, voicemails, activity history, applications, application history, data security keys, stored application authentication credentials.

In embodiments of the present invention, mobile device memory comprises a memory selected from a group consisting of: Random Access Memory (RAM), Read Only Memory (ROM), flash, SD card, hard drive, solid state drive (SSD), NAND, eMMC, USB flash drive. And initiating a limited functionality mobile device state, comprises deleting data stored in mobile device memory. Such deletion can include data selected from a group consisting of: photographs, phone book, contact list, emails, messages, files, calendar entries, phone call history, web browser history, downloads, cached data, voicemails, activity history, applications, application history, data security keys, stored application authentication credentials. The deletion can include all or some and when only some, any combination of the above.

In addition, when initiating a limited functionality mobile device state, the method can include inhibiting communication with external communication networks. Such communication networks as a virtual private network (VPN), a cellular network, a Wi-Fi network, a Bluetooth network, an Internet network or any number or all of these. The limited functionality mobile device state can also include inhibiting the execution of one or more mobile device applications on the device; initiating a termination of authentication session (“log out”) in one or more mobile applications; inhibiting the display of mobile device event notifications; and initiating a mobile device lock state requiring the entry of a user authentication credential.

In embodiments of the present invention, the limited functionality can be begun upon receiving an indication for a geographically present local user; receiving an indication via network communication over a network attached to the mobile device; receiving a mobile device management (MDM) notification; consulting a configuration data specifying operations to perform and performing the specified operations.

In one embodiment, the invention comprises a memory configured to store an executable program comprising a plurality of operations and a processor coupled to the memory, wherein the processor is configured to execute the executable program and executes the steps of receiving in the mobile computing system, an indication to enter a limited functionality mobile device state and initiating in the mobile computing system, a limited functionality mobile device state.

A more detailed explanation of the invention is provided in the following description and claims and is illustrated in the accompanying drawings.

### BRIEF DESCRIPTION OF THE DRAWINGS

FIG. 1 is a representation of a system using the method of the present invention;

FIG. 2 is a flow chart of the functionality of the present invention; and

FIG. 3 is a further flow chart of the functionality of the present invention.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

Referring to FIG. 1, client device 100 embodies a management client module 110, a memory 120, one or more elements of data 130 stored in the memory 120, a communications module 140, a user display module 150, and a user input module 160. The management client module 110 embodies a client module capable of taking device management configuration queries and updates from a remote server 180, referred to as Mobile Device Management or “MDM” in the industry. The management client module 110 can communicate 170 via a communication module such as, among others, the Apple MDM protocol, Google GCM, Apple APNS, Windows Phone Device Management Protocol, and the like. MDM server module 190 is capable of performing management operations on client device 100 via MDM client module 110. Persons having ordinary skill in the art will recognize multiple ways the management client module 110 can be created to achieve the same functionality, without departing from the novel scope of the present invention.

Memory 120 can be a Random Access Memory (RAM), Read Only Memory (ROM), DRAM, Flash memory, NAND memory, NOR memory, hard drive, SSD, SD Card, EMMC Flash, TransFlash, USB drive, persistent memory, non-persistent memory, and the like. Persons having ordinary skill in the art will recognize different means to construct a digital memory module capable of storing digital data for use in this application, without departing from the novel scope of the present invention. The one or more elements of data 130 can include, among other things, photographs, phone book entries, contact list entries, emails, messages, files, calendar entries, phone call history, web browser history, downloads, cached data, voicemails, activity history, applications, application history, data security keys, stored application authentication credentials, and the like. Persons having ordinary skill in the art will recognize further types of data that can be stored in a memory, without departing from the novel scope of the present invention.

Communications module 140 can communicate on a communications network, including but not limited to such networks as Ethernet, Wifi, Bluetooth, CDMA, GSM, LTE, HPSA, cellular, and the like. The user display module 150 embodies a screen to display information to a user of the client device 100. The user input module 160 can include physical keys, physical switches, virtual keyboard, physical keyboard, buttons, toggles, touchscreen input, light sensor, motion sensor, accelerometer, or other means for a user to signal an input to the client device 100. The composition of client device 100 is typical of a mobile device found in the industry, such as, but not limited to, an Android mobile phone, Apple mobile phone, Android mobile tablet, Apple mobile tablet, Apple MacOS X laptop, Windows Phone, Blackberry phone, Windows tablet, Windows laptop, and the like.

Additionally, the client device 100 embodies a suspend logic module 164 and a list of suspend operations 168. The operation of the suspend logic module 164 will be further described in detail below.

Referring now to FIG. 2, a method to initiate a suspend operation for a mobile device is illustrated. The illustration in FIG. 2 represents an embodiment of the suspend logic module 164 (FIG. 1); it will be understood that other embodiments can be made without departing from the novel scope of the present invention. The logic sequence of the method begins 200 by receiving 210 a request from MDM server module 190 (FIG. 1) to enter a suspended state, or receiving 220 a request from the user via user input module 160 (FIG. 1) to enter a suspended state. The logic 164 (FIG. 1) will consult 230 a pre-determined list of suspend operations 168 (FIG. 1) to perform, and then perform 240 each operation on the pre-determined list of suspend operations. The operations may direct the logic to perform one or more of inhibiting actions to data in memory 120 (FIG. 1), deleting data 130 (FIG. 1) in the memory, inhibiting network communication, inhibiting execution of applications, inhibiting event notifications, displaying a notice to the user on a display module, locking the device, logging out of active sessions, and the like. Persons having ordinary skill in the art will recognize further types of operations that can be performed to reduce, limit, or inhibit the full functional operation of the device. The logic repeats 270 the performance of indicated operations until all operations on the list of suspend operations are completed. At this point, the logic concludes 290 and the client device 100 (FIG. 1) is now considered to be in a suspended state.

Referring now to FIG. 3, a method of operation to exit a suspended state in the present invention is illustrated. FIG. 3 represents an embodiment of the suspend logic module 164 (FIG. 1). The logic sequence of this aspect of the method begins 300 by receiving 310 a request from MDM server module 190 (FIG. 1) to exit a suspended state, or receiving 320 a request from the user via user input module 160 (FIG. 1) to exit a suspended state. The logic will consult 330 the pre-determined list of suspend operations 168 (FIG. 1) to perform, and then perform 340 each operation on the pre-determined list of suspend operations in a manner to reverse the operation(s) previously performed as part of the process to enter a suspended state (illustrated in FIG. 2). The operations may direct the logic to perform one or more of uninhibiting access to data in memory, uninhibiting network communication, uninhibiting execution of applications, uninhibiting event notifications, displaying a notice to the user on a display module, and the like. Persons having ordinary skill in the art will recognize further types of operations that can be performed to restore the full functional operation of the device, without departing from the novel scope of the present invention. The logic repeats 370 the performance of indicated operations until all operations on the list of suspend operations are completed. At this point, the logic concludes 390 and the client device 100 (FIG. 1) is now considered to be in a normal (unsuspended) state.

In various embodiments of the present invention, a mobile device receives an indication to enter a limited functional state. In some embodiments, the indication may be a local user-initiated event, a remote administrator-initiated event, an automated event initiated by an external computing system, and the like. In some embodiments, the indication is implemented in the mobile device as a button, checkbox, switch, other visual element, and the like. In some embodiments, the indication can be received over a communications network. For example, the mobile device could receive a Mobile Device Management (MDM) notification, and the like. In operation, when a mobile device receives an MDM notification, the mobile device would be switched to a limited functional state.

Some embodiments of the present invention include a mobile device programmed to receive an indication to exit the limited functional state. In some embodiments, the indication may be a local user-initiated event, a remote administrator-initiated event, an automated event initiated by an external computing system, and the like. In some embodiments, the indication is implemented in the mobile device as a button, checkbox, switch, other visual element, and the like. In some embodiments, the indication can be received over a communications network. For example, the mobile device could receive a Mobile Device Management (MDM) notification, and the like. In operation, when the mobile device receives an MDM notification, the mobile device would be switched to a full (or fuller) functional state.

In some embodiments, when a local mobile device user desires to exit the limited functional state, the mobile device may display a visual element to prompt the user for a password, PIN code, and the like. In such embodiments, the mobile device may only exit the limited functional state (e.g. return to full functional state) if a valid password, PIN code, and the like is provided. Such embodiments ensure a properly authenticated user is present to the mobile device, whereby preventing the mobile device from exiting limited functional state prematurely. In some embodiments, other forms of identification may include the use of an RF tag, a NFC device, other hardware unique to the user, biometric data (such as voice, retina, fingerprint), and the like may be used to authenticate the user.

In various embodiments, entering the limited functional state of the mobile device may involve inhibiting access to data stored in mobile device memory. The mobile device memory can be Random Access Memory (RAM), Read Only Memory (ROM), flash, SD card, and the like. In some examples, the data stored in the memory can be photographs, phone book, contact list, emails, messages, files, calendar entries, phone call history, web browser history, downloads, cached data, activity history, applications, application history, and the like. In light of the present patent application, one of ordinary skill in the art will recognize that many other types of data may be protected using the herein described techniques.

In some embodiments, entering the limited functional state of the mobile device may involve deleting access to data stored in mobile device memory. For example, access to the web browser history, activity history, phone call history, cached data, and the like can be deleted.

In various embodiments, entering the limited functional state of the mobile device may involve inhibiting access to one or more communication networks by the mobile device. The communication networks can be a cellular network, a Virtual Private Network (VPN), a Wi-Fi network, a Bluetooth network, and the like. For example, the limited functional state may allow the use of the cellular network to make phone calls, but inhibit the use of the Wi-Fi and VPN to access the Internet.

In various embodiments, entering the limited functional state of the mobile device involves inhibiting the ability of the mobile device to execute one or more mobile device applications. For example, the limited functional state may allow the execution of all applications except the Email application, effectively preventing access to reading email.

In various embodiments, entering the limited functional state of the mobile device involves inhibiting access to or deleting stored mobile application authentication credentials. Many mobile device applications offer the ability to “log in” to a remote service using a set of user credentials (for example a username, password, PIN, and the like). Further, for the convenience of the user, many mobile device applications typically offer the ability to “stay logged in” to the remote service, whereby the mobile device application stores the user credentials to a mobile device memory. Subsequent uses of the mobile application may then use the stored user credentials, whereby the user credentials do not need to be newly supplied by the user to use the remote service. In some embodiments, access to these cached or stored credentials may be inhibited, deleted, and the like. This leads to the application being “logged out”, and requires the user to newly provide user credentials during the next use of the application to “log back in.”

In various embodiments, entering the limited functional state of the mobile device involves inhibiting access to or deleting stored data security keys. In some examples, various data on the mobile device may be secured by encryption, and the encryption security would require an encryption data security key in order to decrypt the data for subsequent utilization. Similar to the above, typical mobile device implementations will store, or “cache” the data security key for subsequent operations on an encrypted data. By inhibiting access to or deleting the stored/cached data security key, the encrypted data becomes inaccessible in various embodiments. Typically, the data remains inaccessible until access to a proper data security key is subsequently obtained.

In various embodiments, entering the limited functional state of the mobile device involves inhibiting the display of incoming message and data-related notifications. Typical mobile devices will display to the user a notification of an event, such as receiving an email, receiving an instant message, completion of a file download, availability of a new application, availability of new data, and the like. Inhibiting the notifications prevents the display of the event details.

In various embodiments, the embodied combination of operations performed during the entrance of a limited functional state of the mobile device can be explicitly programmed in the mobile device. In some embodiments, the combination of operations can be specified by configuration data. The configuration data can be created and/or maintained by the user, an administrator, a remote management service (e.g. MDM), and the like.

In one scenario, embodiments of the present invention are used by a mobile device to implement a “safe mode” limited functionality state, whereby the user of a mobile device can initiate the “safe mode” limited functional state before sharing their mobile device to a third party. For example, a third-party may request the use of the mobile device to place a phone call. The user of the mobile device may wish to fulfill that request, but may be concerned about whether the third-party will access personal/private data on the mobile device, such as photographs, email, and other private information. The user of the mobile device then configures a “safe mode” defined state (via an application or other user-interactive capability programmed on the mobile device) that inhibits access to all personal data (e.g. photographs, data files, email, calendar, etc.), inhibits access to stored application authentication credentials, inhibits execution of all applications, inhibits access to non-cellular communications networks, and the like, as desired. The user then initiates the entry into this configured limited functional state (via an application or other user-interactive capability programmed on the mobile device). In this limited functional state, the mobile device is effectively prevented from doing anything notable other than placing a phone call. The user has confidence that the third-party cannot access private data of the user; utilize logged-in applications (e.g. Facebook, Twitter, etc.), abuse communication networks use, etc. After the third-party is finished using the mobile device, it is returned to the user. The user then initiates (via an application or other user-interactive capability programmed on the mobile device) the exit of the limited functional state, e.g. return to full functional state. In various embodiments, to do so, the user may be prompted to enter in a PIN, password, and the like to confirm the identity of the user (e.g. it is not third-party attempting to exit the limited functional state). Upon successful authentication of the user, the mobile device returns to a full functional state and the user can continue to operate the mobile device as normal.

In another scenario, the described invention is used by a mobile device to implement a “privacy mode” limited functional state, whereby the user of a corporate administratively managed mobile device (e.g. managed by MDM, etc.) can initiate a limited functional state to perform personal actions that are not subject to administrative limits or administrative monitoring/review. For example, a corporation may establish a management relationship with a mobile device, to allow the mobile device to access corporate resources. One example relationship would be an MDM enrollment. Upon entering that management relationship, the mobile device can be subject to corporate administrative limitations that restrict resource access (e.g. web filtering to disallow access to non-business-related web sites), may have all activity and/or network traffic inspected for compliance to corporate requirements, may have all email, message, and/or network traffic stored for corporate backup or retention needs, etc.

In this scenario, the user then recognizes they want to perform personal activities on the mobile device, but is restricted by the corporate administrative limits placed on the mobile device, and/or is concerned about user privacy due to corporate monitoring of activity. Thus the user initiates entry of the mobile device into a “privacy mode” limited functional state. The “privacy mode” limited functional state inhibits access to all corporate data (e.g. corporate email, corporate files, corporate calendar, etc.), inhibits access to corporate mobile device applications, inhibits access to all application authentication credentials involving a corporate authentication credential, inhibits network communications to a corporate network (e.g. via VPN, Wi-Fi, etc.), inhibits or deletes the data security keys for all secured corporate data, etc. In some embodiments, the “privacy mode” may allow mobile device functionality that is not allowed while coupled to the corporate network. For example, while coupled to the corporate network, access to the Internet may be restricted to certain sites, whereas while in “privacy mode,” the user may not be restricted on the Internet.

In some embodiments, a notification may also be sent to the corporation that the user entered into a “privacy mode” limited functional state, whereby allowing the corporation to note the new mobile device state and further disable any activity monitoring, etc. At this point, the user is effectively prevented from accessing corporate resources, data, etc., and may not be subject to corporate monitoring and activity limitation restrictions.

In some embodiments, functionality related to corporate resources and corporate data (e.g. Intranet, local server data, etc.) may be limited, however access to personal email, personal data, etc. may still be possible. In such embodiments, the user may be free to perform personal activities (e.g. online banking, viewing of socially-contested material, access to healthcare records, private communications, etc.). Upon finishing the personal activities, the user then initiates (via an application or other user-interactive capability programmed on the mobile device) the exit of the limited functional state, e.g. return to “full” functional state (e.g. “corporate state”). A notification may again be sent to the corporation the user has left “privacy mode” limited functional state, and re-enables activity monitoring, data backups, etc. as appropriate. In various embodiments, the mobile device may remove some or all previous inhibits and may restore normal access to corporate resources (e.g. allow access to corporate email, files, data, calendar, VPN, Wi-Fi, data security keys, etc.). Accordingly, the mobile device returns to a full functional state and the user can continue to operate the mobile device as normal.

In another scenario, embodiments of the present invention is used by a mobile device to implement a “suspend mode” limited functional state, whereby the corporate administrator of an corporate administratively managed mobile device (e.g. managed by MDM, etc.) can initiate a limited functional state to restrict access to corporate resources. For example, a corporation may establish a management relationship with a mobile device, to allow the mobile device to access corporate resources. One example relationship would be an MDM enrollment. In such a case, the corporation may allow the mobile device to access corporate communications networks (e.g. VPN, Wi-Fi, etc.), and allow the mobile device to retain corporate data (e.g. corporate email, files, calendar, data, data security keys, etc.) in the memory of the mobile device. Such an arrangement is typical in current industry Bring Your Own Device (BYOD) relationships between corporations and employee-provided mobile devices.

In various embodiments, at some point, the corporate administrator can determine it is necessary or advantageous to temporarily restrict access to corporate resources on the mobile device. For example, the mobile device was reported stolen/lost, the employment of the employee using the mobile device is suspended, litigation-related requests are made, etc. The administrator can initiate a management notification to the mobile device to initiate entering a “suspend mode” limited functional state. The “suspend mode” limited functional state inhibits access to or deletes some or all corporate data (e.g. corporate email, corporate files, corporate calendar, etc.) on the mobile device, inhibits access to or deletes corporate mobile device applications, inhibits access to or deletes all application authentication credentials involving a corporate authentication credential, inhibits network communications to a corporate network (e.g. via VPN, Wi-Fi, etc), inhibits or deletes the data security keys for all secured corporate data, and the like. At this point, the user may be effectively prevented from accessing corporate resources, data, etc. In some embodiments, only functionality related to corporate resources and corporate data has been limited—access to personal email, personal data, etc. is still possible.

In another embodiment the present invention can be used to provide smart phone communication capabilities to an adolescent with control left to a guardian. Similar to the corporate scenario, the guardian can provide the device with access to the cellular telephone network and some “apps” but not the Internet and other “apps”. In addition, as the adolescent matures more privileges on the device can be freed for use and/or withdrawn for disciplinary reasons. Further, Internet access can be allowed on weekends and over holidays. The devices of a group of adolescents can also be put under the control of an administrator, such as at a school or summer camp, such that emergency communications alone can be made during activity hours, limited communication is available during the school/camp day and then the device is freed, to parental management after school hours. Children are, in this manner, allowed to maintain their devices such that they can receive emergency messages from home and can request help if needed via telephone. As such, adolescents are permitted to maintain their devices on them (instead of having to surrender them or turn them off) while minimizing their access to distractions via their devices; in addition, the ability to track and or maintain contact with them is maintained. Control of the devices also minimizes the loss thereof due to misplacement or theft.

In another scenario variation, particular to when the mobile device is lost or stolen, the mobile device can further be put into a “locked” state whereby the phone requires entry of a PIN, password, plugging into a particular computer, access to a particular network, etc. before it can be further used. At a subsequent point in time, the corporate administrator can determine it is no longer necessary or advantageous to temporarily restrict access to corporate resources on the mobile device. For example, the mobile device was found/recovered; the employment of the employee using the mobile device is re-instated, etc. The administrator can initiate a management notification to the mobile device to initiate leaving a “suspend mode” limited functional state and returning to normal functional state, whereby access to corporate resources is allowed. The mobile device may remove previous inhibits and restores normal access to corporate resources (for example allowing access to corporate email, files, data, calendar, VPN, Wi-Fi, data security keys, etc.). Accordingly, the mobile device returns to a full functional state and the user can continue to operate the mobile device as normal.

One variation to the previously described scenario of “suspend mode” involves using an external computing system to initiate a management notification to the mobile device to enter a “suspend mode” limited functional state of the device. In such embodiments, little or no administrative involvement is necessary to initiate the state change. The external computing system can make a determination to enter the “suspend mode” limited functional state. For example, the external computing system can determine the mobile device has left an allowed geographical environment/location, and warrants suspending access to corporate resources while not in the allowed geographical environment/location. In further example, the external computing system can receive notice from corporate systems (for example IT systems, HR systems, etc.) regarding the suspension of the employee's employment, thus warranting suspending access to corporate resources on that mobile device. In another example, the external computing system can witness a “lost mobile device” report (e.g. Apple iOS “Find My iPhone”), and respond by suspending access to corporate resources on the mobile device until the mobile device has been determined to be found/recovered. In still other embodiments, a “suspend mode” may be automatically pushed to users periodically. In such cases, to exit the “suspend mode” the user may have to enter their original password, and change their password at the same time.

Although an illustrative embodiment of the invention has been shown and described, it is to be understood that various modifications and substitutions may be made by those skilled in the art without departing from the novel spirit and scope of the invention.

What is claimed:

1. A computer-implemented method for limiting access in a mobile device programmed for the method, comprising the steps of:
receiving in the mobile device, an indication to enter a limited functionality mobile device state; and
initiating in the mobile device, a limited functionality mobile device state.

2. The method of claim 1 further comprising the steps of:
receiving in the mobile device, an indication to exit a limited functionality mobile device state; and
initiating in the mobile device, a full functionality mobile device state.

3. The method of claim 1 wherein initiating in the mobile device, a limited functionality mobile device state, comprises inhibiting in the mobile device, access to data stored in mobile device memory.

4. The method of claim 3 wherein inhibiting in the mobile device, access to data stored in mobile device memory comprises inhibiting access to data selected from a group consisting of: photographs, phone book, contact list, emails, messages, files, calendar entries, phone call history, web browser history, downloads, cached data, voicemails, activity history, applications, application history, data security keys, stored application authentication credentials.

5. The method of claim 3 wherein mobile device memory comprises a memory selected from a group consisting of: Random Access Memory (RAM), Read Only Memory (ROM), flash, SD card, hard drive, solid state drive (SSD), eMMC, NAND, USB flash drive.

6. The method of claim 1 wherein initiating in the mobile device, a limited functionality mobile device state, comprises deleting in the mobile device, data stored in mobile device memory.

7. The method of claim 6 wherein deleting in the mobile device, data stored in mobile device memory comprises deleting data selected from a group consisting of: photographs, phone book, contact list, emails, messages, files, calendar entries, phone call history, web browser history, downloads, cached data, voicemails, activity history, applications, application history, data security keys, stored application authentication credentials.

8. The method of claim 6 wherein mobile device memory includes memory selected from a group consisting of: Random Access Memory (RAM), Read Only Memory (ROM), flash, SD card, hard drive, solid state drive (SSD), eMMC, NAND, USB flash drive.

9. The method of claim 1 wherein initiating in the mobile device, a limited functionality mobile device state, comprises inhibiting in the mobile device, communication with external communication networks.

10. The method of claim 10 wherein inhibiting in the mobile device, communication with external communication networks comprises inhibiting communication to a network selected from a group consisting of: a virtual private network (VPN), a cellular network, a Wi-Fi network, a Bluetooth network, an Internet network.

11. The method of claim 1 wherein initiating in the mobile device, a limited functionality mobile device state, comprises inhibiting in the mobile device, execution of one or more mobile device applications.

12. The method of claim 1 wherein initiating in the mobile device, a limited functionality mobile device state, comprises initiating a termination of authentication session (“log out”) in one or more mobile applications.

13. The method of claim 1 wherein initiating in the mobile device, a limited functionality mobile device state, comprises inhibiting the display of mobile device event notifications.

14. The method of claim 1 wherein initiating in the mobile device, a limited functionality mobile device state, comprises initiating a mobile device lock state requiring the entry of a user authentication credential.

15. The method of claim 1 wherein receiving in the mobile device, an indication to enter a limited functionality mobile device state comprises receiving an indication for a geographically present local user.

16. The method of claim 1 wherein receiving in the mobile device, an indication to enter a limited functionality mobile device state comprises receiving an indication via network communication over a network attached to the mobile device.

17. The method of claim 16 wherein receiving an indication via network communication over a network attached to the mobile device comprises receiving a mobile device management (MDM) notification.

18. The method of claim 1 wherein initiating in the mobile device, a limited functionality mobile device state, comprises:
consulting in the mobile device, a configuration data specifying operations to perform; and
performing in the mobile device, the specified operations.

19. A mobile computing system for initiating a limited functionality operational state comprising:
a memory configured to store an executable program comprising a plurality of operations; and
a processor coupled to the memory, wherein the processor is configured to execute the executable program, wherein the processor is configured for a method that comprises the steps of:
receiving in the mobile computing system, an indication to enter a limited functionality mobile device state; and
initiating in the mobile computing system, a limited functionality mobile device state.
